(19) United States
(12) Patent Application Publication
(10) Pub. No.: US 2004/0240162 A1
(43) Pub. Date: Dec. 2, 2004

(54) Housing of electronic device with a side key assembly

(76) Inventors: Chih-Neng Hsu, Tu-Chen (TW); Tai Wei Chiang, Tu-Chen (TW); Baojiang Chen, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/807,050

(22) Filed: Mar. 22, 2004

(30) Foreign Application Priority Data
Mar. 21, 2003 (TW) 92204447

(51) Int. Cl. G06F 1/16

(52) U.S. Cl. 361/680

(57) ABSTRACT

A housing (100) of an electronic device with a side key assembly (200) mounted therein includes a side wall. The side key assembly comprises a key portion (120), a flexible panel (140), and a flexible printed circuit board (164). The flexible printed circuit board has conducting tracks formed thereon. The flexible panel locates between the flexible printed circuit board and the key portion, and has domes (142) defined thereon. When works, the depressed key portion exerts a force to the flexible panel until one of the domes contacts to the flexible printed circuit board and actuates the conducting tracks formed thereon.

### BACKGROUND OF THE INVENTION

1. Field of the Invention

The present invention relates to a housing of an electronic device, and especially to a housing of a portable electronic device with a side key assembly.

2. Description of the Related Art

Many electronic devices such as mobile phones have a housing with an interior compartment for receiving a printed circuit board therein. For the sake of convenience, a mobile phone usually sets a side key swich on an outside sidewall of the housing so that the user can operate the electronic device by a single finger to finish receiving a call, opening a background light, adjusting a volume or rolling a menu. Generally, the switch or a portion thereof is located on the circuit board which is mounted within the housing. A button or similar actuator is situated on an outside sidewall of the housing such that an interface portion is externally accessible to a user. And an contact portion positioned adjacent to the switch. When the user depresses the interface portion, the contact portion engages and actuates the switch.

A device of this type is known, for example, from U.S. Pat. No. 5,749,457, as shown in FIGS. 4 and 5. This patent discloses an electronic device 100 including a plurality of side keys 200. Each side key 200 includes an actuator button 210 and a shaft 220. The button 210 is made of resilient and elastic material in a one-piece construction, and includes an externally accessible user interface portion 211, an internally positioned actuator member 212, and a wall portion 214. The button 210 is anchored to a housing member of the electronic device 200 by the wall portion 214 anchoring to the shaft 220.

In operation, force is applied to the user interface 211 of the button 210 in a direction 202 which is substantially orthogonal or 90 degrees, from the direction of actuation 201 of the switch 232 on a circuit chip 230. The actuator button 210 is responsive to the force exerted in a direction normal to the user interface surface 211 to pivot the actuator member 212. As a result, the actuator member 212 exerts an actuating force on the switch member 232. When a force is applied to the user interface surface 211, the actuator member 212 pivots until the actuator surface 216 engages with the switch member 232. Thus, the actuator member 212 pivots such that it exerts a corresponding force on the switch member 232 at a certain angle with regard to the direction of the force exerted on the user interface surface 211. However, in the prior art, the side key 200 is reposited by bias force exerted by the shaft 220 suffered from the actuator member 212 pivots. When exerting a greater force to the button 210, the shaft 220 provides greater spring bias return force for the interface portion 211 and actuator member 212. This makes the button 210 drift off the position where it should return to. To assure the key 210 cooperates with the switch 232 well, the distance between the wall portion 214 and the switch 232 should not be too small. But, where and place the shaft 220 located is in charged to the distance, this is not easy to control and the shaft becomes unstable after frequent usage, and leads to a change of the distance.

In another prior art, referring to FIG. 6, a side mounted key assembly 300 is disclosed in U.S. Pat. No. 6,166,337. The side key assembly 300 includes a key portion 310 and a movable contact portion 320. The key portion 310 has a movable key portion 312 and a movable contact actuator portion 314 cooperating with the movable key portion 312 and cooperating with the movable contact portion 320. The contact actuator portion 314 has the form of a cone rounded off near to the free end 323. The movable contact portion 320, near to the free end 328 thereof and near to the free end 323 of the contact actuator portion 314, has a surface 327 that is at an angle relative to the direction of movement P of the contact actuator portion 314. The key portion 310 and the contact portion 320 cooperate with an elastic carrier plate 17 which includes a first part 316, a second part 326, and a third part 324. In operation, force is applited to the movable key portion 312 in the direction P, the movable key portion 312 is responsive to the force exerted in a direction normal to contact actuator portion 314. The contact actuator portion 314 moves till it's free end 323 biases to the surface 327 of the movable contact portion 320. The movable contact portion 320 moves in the direction Q towards the printed circuit board (not lablled). When the force is eliminated, the movable contact portion 320 is reposited by a return force that the third part 324 provides. However, the movable contact portion 320 is not only suffer from a force in perpendicularity, but also suffer from a force in horizontal. The force in horizontal makes the movable contact portion 320 drift off. This affects performance of the side key assembly 300 when it works.

Therefore, an improved housing of an electronic device with a side key assembly having simple structure, easy assembly and stable performance is desired.

### SUMMARY OF THE INVENTION

Accordingly, an object of the present invention is to provide a housing of an electronic device with a side key assembly having simple structure, easy assembly and stable performance.

To achieve the above object, a housing of an electronic device with a side key assembly comprises a side wall. The side key assembly comprises a key portion, a flexible panel, and a flexible printed circuit board. The flexible printed circuit board has conducting tracks formed thereon. The flexible panel locates between the flexible printed circuit board and the key portion, and has domes defined thereon. When a force is applied to the key portion, the depressed key portion exerts a force to the flexible panel until one of the domes contacts to the flexible printed circuit board and actuates the conducting tracks formed thereon.

In a preferrd embodiment, two stop walls extend from an inner side of the side wall. Each stop wall is in a “L” shape and confronts to each other near to the inner side of the side wall. There is a recess formed in the side wall corresponding with the two stop walls. A receiving space is defined in the side wall between the recess and the two stop walls. The side key assembly is located in the receiving space.

Other objects, advantages and novel features of the present invention will be apparent from the following detailed description of preferred embodiments thereof with reference to the attached drawings, in which:

### BRIEF DESCRIPTION OF THE DRAWINGS

FIG. 1 is an exploded perspective view of a housing with a side key assembly of the present invention;

FIG. 2 is assembled view of the housing with a side key assembly shown in FIG. 1;

FIG. 3 is a partially enlarged view of the side key encircled in III of the FIG. 2;

FIG. 4 is an exploded view of a conventional housing with side keys assembly;

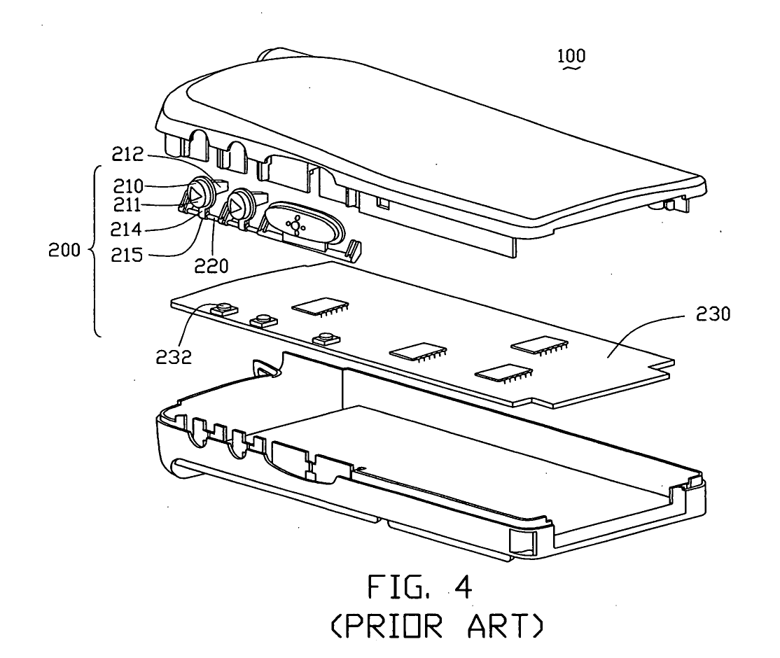

FIG. 5 is a fragmentary cross-sectional view of the housing of the FIG. 4; and

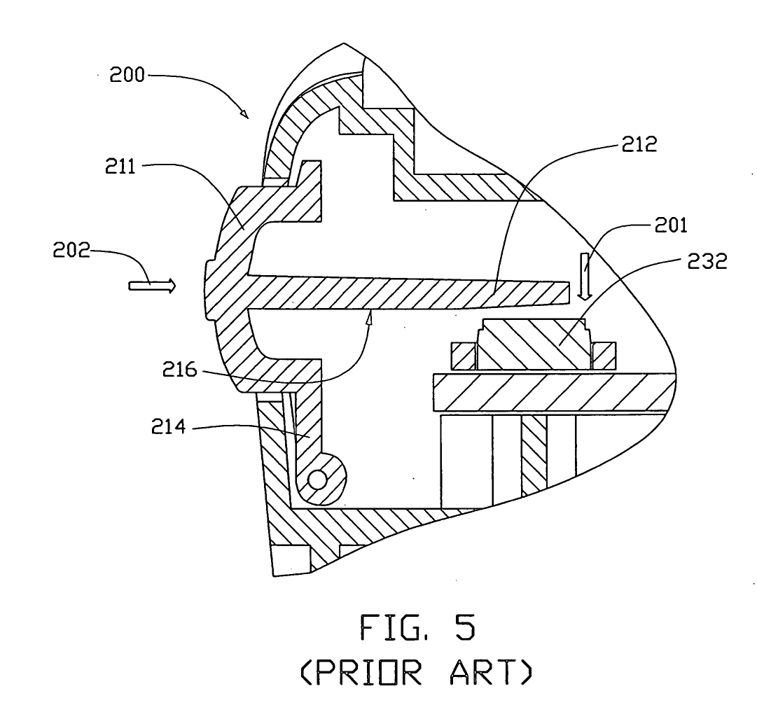

FIG. 6 is a cross-sectional view of another conventional housing with a side key assembly.

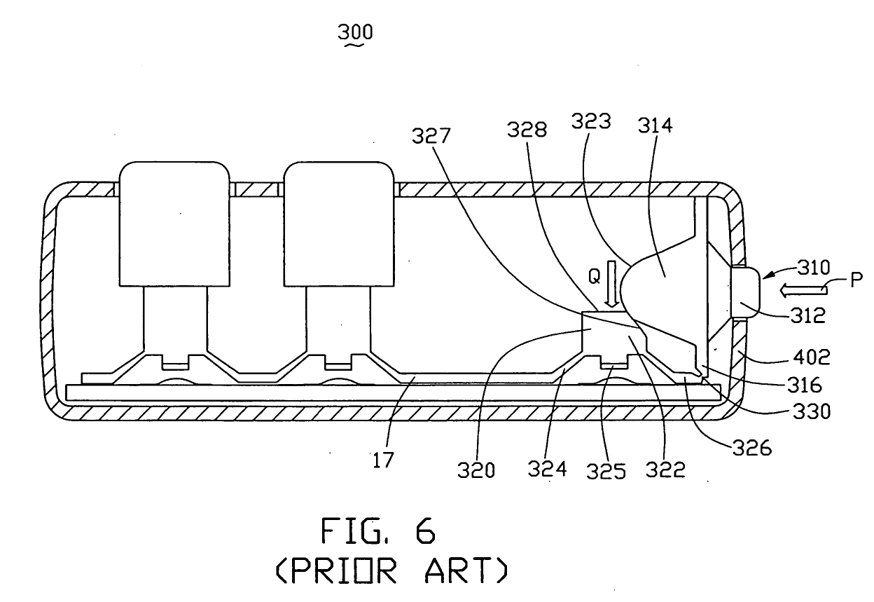

### DETAILED DESCRIPTION OF THE PREFERRED EMBODIMENTS

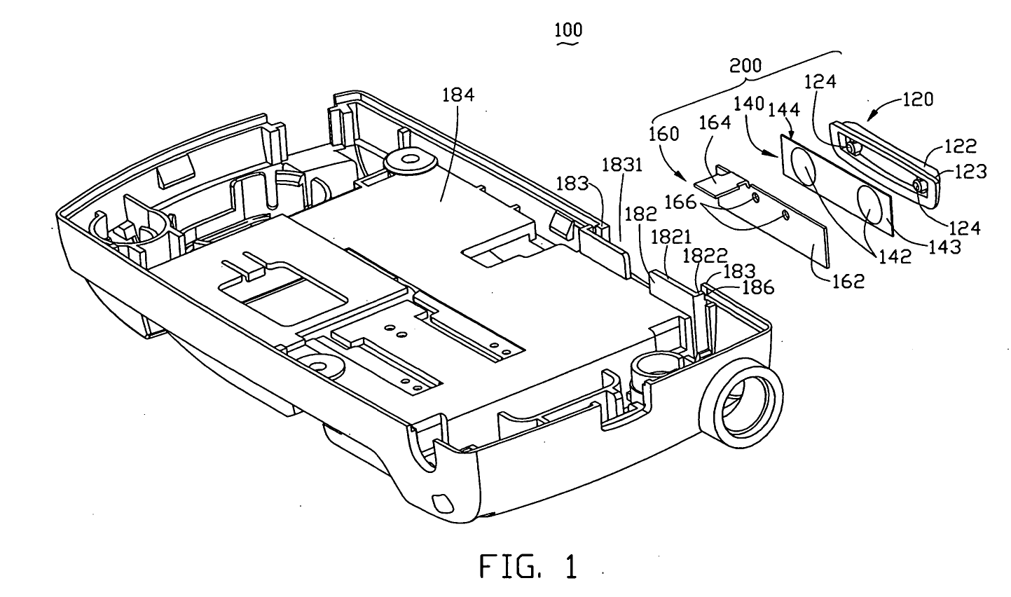

FIG. 1 shows a housing 100 of an electronic device (not shown) with a single side key assembly 200. The housing 100 comprises a side wall 183 and two stop walls 182. A printed circuit board (not shown) is accommodated in the housing 100 for providing electrically contact with the electronic device. Each stop wall 182 extends from an inner side (not lablled) of the side wall 183. The two stop walls 182 present inside the housing 100 near to the side wall 183. Each stop wall 182 is in a “L” shape and confronts to each other near to the inner side of the side wall 183. Each stop wall 182 comprises a long arm 1821 and a short arm 1822. Each long arm 1821 is in parallel to the side wall 183. The two long arms are aligned each other with a space (not lablled) defined therebetween. Each short arm 1822 extends from the bottom wall (not lablled) of the housing 100. Two ends of each short arm 1822 are respective near to the inner side of the side wall 183 and the long arm 1821. The space between the two short arms 1822 is longer than the side key assembly 200. A recess 1831 is formed in the side wall 183 corresponding with the two stop walls 182. A width of the recess 1831 is shorter than the distance between the two short arms 1822. A receiving space 186 is defined in the side wall 183 between the recess 1831 and the two stop walls 182.

The side key assembly 200 comprises a key portion 120, a flexible panel 140, and an electrical component 160 having an electrical panel 162 and a flexible printed circuit board 164. The key portion 120 has a body portion 123 and a user interface 122 which protrudes from one face of the body portion 123. The body portion 123 and the user interface 122 define an opening space (not lablled). Two contact portions 124 extend from one inner side of the user interface 122 and are contained in the opening space. The two contact portions 124 are located in two ends of the user interface 122, respectively.

The flexible panel 140 is a rectangular panel, having a first surface 143 and a second surface 144. There are two domes 142 located on the second surface 144. Each dome 142 corresponds to each contact portion 124.

The electrical panel 162 is a rectangular panel with two holes 166 defined therethrough. The flexible printed circuit board 164 is coupled to the electrical panel 162 by means of hot pressure, and two pair conducting tracks are formed thereon. One end of each conducting track contacts has a contact pointer (not shown) on the electrical panel 162, and each pair conducting tracks would not electrically contact each other.

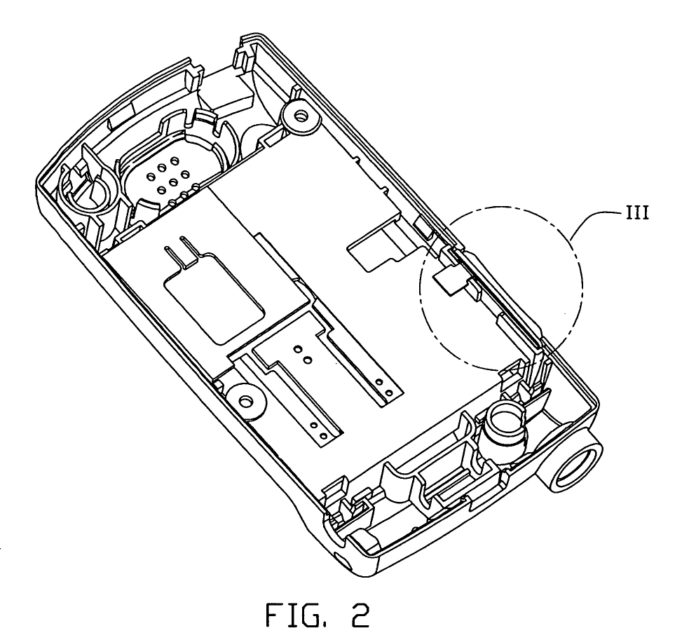

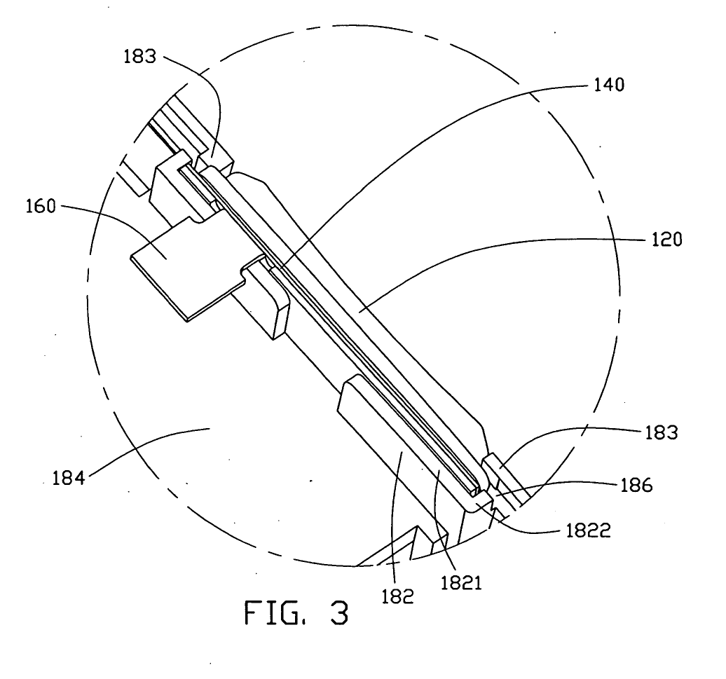

Referring to FIGS. 2 and 3, in assembly, the electrical component 160, the flexible panel 140 and the key portion 120 are placed into the receiving space 186 in turn. Each hole 166 formed on the electrical panel 162 corresponds to a protruding portion (not shown) on each stop wall 182 contained in the hole 166 for holding the electrical panel 162. The flexible printed circuit board 164 crosses over one long arm 1821 and contacts to the printed circuit board builted in the housing 100 by means of hot pressure, so that the conducting tracks defined on the two printed circuit boards can electrically contact each other. The flexible panel 140 locates between the electircal component 160 and the key portion 120, and the domes 142 contact with but not pressed by the contact portions 124 of the key portion 120. The side key assembly 200 is assembled in the receiving space 186 of the side wall 183 and locked by the body portion 123, the user interface 122 protrudes out the side wall 183 so that user can operate it.

In operation, a force is applited to one end of the user interface 122, the contact portion 124 defined thereon is pressed, actuating the dome 142 coresoponding to the contact portion 124. The dome 142 is responsive to the force exerted in a direction normal to contact the electrical panel 162 and actuates the electrical pointers on the electrical panel 162. The two conducting tracks coresponding to the two electrical pointer are responsive to the actuation of the dome 142 and electrically conduct with the electrically conducting portion (not shown) of the printed circuit board builted in the housing 100. Thus a signal of the operation passes to the printed circuit board in the housing 100 from the flexible printed circuit board 160. When the force is eliminated, the dome 142 is reposited by it's elasticity and the contact portion 124 is back to its original position by a return force of the dome 142.

The apparatus of the present invention utilizes one flexible panel 142 to actuate the electrical pointer to make the signal of the operation pass to the printed circuit board builted in the housing 100 from a flexible printed circuit board 164. When reposition, there is no additional components to do it, this makes the apparatus has a simple structuer and stable performance.

It is understand, there the electrical panel 162 can be canceled, and the electrical pointer is formed on the flexible printed circuit board 164 derectly. This arrangment could also achieve the purpers.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A housing of an electronic device comprising:
a side wall; and
a side key assembly, which engaged with the side wall, and comprising:
a key portion;
a flexible panel, having domes formed thereon and corresponding to the key portion; and
a flexible printed circuit board, having conducting tracks formed thereon; wherein
the flexible panel is arranged between the key portion and the flexible printed circuit board and each dome corresponds to a end of each conducting track such that when the key portion is depressed, it exerts a force and presses the flexible panel, and in responsive this pressure, one of the domes deformed on the flexible panel has a distortion and depresses to the flexible printed circuit board to actuate the conducting tracks on the flexible printed circuit board.

2. A housing of an electronic device with a side key assembly as described in claim 1, wherein the side key assemble further comprises an electronical panel, which electrical contactes with the conducting tracks formed on the flexible printed circuit board.

3. A housing of an electronic device with a side key assembly as described in claim 2, wherein the flexible printed circuit board couples with the electronical panel by means of hot pressure.

4. A housing of an electronic device with a side key assembly as describled in claim 3, wherein the key portion comprises a body portion, a user interface extending from the body portion and an contact portion extending from one inner side of the user interface.

5. A housing of an electronic device with a side key assembly as described in claim 4, wherein the side wall further comprises a plurality of stop walls, and an receiving space formed therebetween.

6. A housing of an electronic device with a side key assembly as described in claim 5, wherein each stop wall is in a “L” shape, and includs a long arm and a short arm, the long arm is parallel to the side wall, and the short arm extends from a bottom wall of the housing and near to the side wall.

7. A housing of an electronic device with a side key assembly as described in claim 6, wherein the side wall has a recess which responding with the stop wall, and a width of the recess is shorter than a distance of the two short arms.

8. A housing of an electronic device with a side key assembly as described in claim 7, wherein the key portion, the flexible panel and the electronical panel are placed in the receiving space, the side wall blocks the body portion of the key portion and the user interface extends out the recess.

9. A housing of an electronic device with a side key assembly as described in claim 1, a printed circuit board is builted in the housing, which electrically contacts with the conducting tracks formed on the flexible printed circuit board.

10. A housing of an electronic device with a side key assembly as described in claim 9, wherein the flexible printed circuit board is coupled to the printed circuit board by means of hot pressure.

11. A side key assembly for a housing of an electronic device, comprising:
a key portion;
a flexible panel, having domes formed thereon and corresponding to the key portion; and
a flexible printed circuit board, having conducting tracks formed thereon; wherein
the flexible panel is arranged between the key portion and the flexible printed circuit board and each dome corresponds to a end of each conducting track such that when the key portion is depressed, it exerts a force and presses the flexible panel, and in responsive this pressure, one of the domes deformed on the flexible panel has a distortion and depresses to the flexible printed circuit board to actuate the conducting tracks on the flexible printed circuit board.

12. A side key assembly for a housing of an electronic device as described in claim 11, wherein the housing further comprise a side wall, the side key assembly engages with the side wall.

13. A side key assembly for a housing of an electronic device as described in claim 12, wherein the side key assemble further comprises an electronical panel, which electrically contactes with the conducting tracks formed on the flexible printed circuit board.

14. A side key assembly for a housing of an electronic device as described in claim 13, wherein the flexible printed circuit board couples with the electronical panel by means of hot pressure.

15. A side key assembly for a housing of an electronic device as described in claim 14, wherein the key portion comprises a body portion, a user interface extending from the body portion, and a contact portion extending from one inner side of the user interface.

16. A side key assembly for a housing of an electronic device as described in claim 15, wherein the side wall further comprises a plurality of stop walls, and a receiving space formed therebetween.

17. A side key assembly for a housing of an electronic device as described in claim 16, wherein each stop wall is in a “L” shape, and comprises a long arm and a short arm, the long arm is parallel to the side wall, and the short arm extends from a bottom wall of the housing and near to the side wall.

18. A side key assembly for a housing of an electronic device as described in claim 17, wherein the side wall has a recess which responding with the stop wall, and a width of the recess is shorter than a distance of the two short arms.

19. A side key assembly for a housing of an electronic device as described in claim 18, wherein the key portion, the flexible panel and the electronical panel are placed in the receiving space, the side wall blocks the body portion of the key portion and the user interface extends out the recess.

20. A side key assembly for a housing of an electronic device as described in claim 19, a printed circuit board is builted in the housing, which electrical contacts with the conducting tracks formed on the flexible printed circuit board.

21. A side key assembly for a housing of an electronic device as described in claim 20, wherein the flexible printed circuit board is coupled to the printed circuit board by means of hot pressure.

22. A housing of an electronic device comprising:
a side wall, and
a side key assembly, which engages with the side wall, and comprising:
a key portion;
a flexible panel, which substantially abutting against the key portion; and
a flexible printed circuit board, having conducting tracks formed thereon; wherein
the flexible panel is arranged between the key portion and the flexible printed circuit board such that when the key portion is depressed, it exerts a force and presses the flexible panel, and in response this pressure, the flexible panel has a distortion and depresses to the flexible printed circuit board to actuate the conducting tracks on the flexible printed circuit board.

23. The housing as described in claim 22, wherein said flexible panel is metallic, and said flexible printed circuit board is further connected to an electrical panel which is engaged with said metallic flexible pane.
